(19) United States
(12) Patent Application Publication
(10) Pub. No.: US 2016/0086400 A1
(43) Pub. Date: Mar. 24, 2016

(54) WIRELESS ACCESS CONTROL SYSTEM INCLUDING DISTANCE BASED LOCK ASSEMBLY AND REMOTE ACCESS DEVICE ENROLLMENT AND RELATED METHODS

(71) Applicant: Unikey Technologies Inc., Winter Park, FL (US)

(72) Inventors: Philip C. Dumas, Orlando, FL (US); Justin Handville, Largo, FL (US)

(21) Appl. No.: 14/881,762

(22) Filed: Oct. 13, 2015

Related U.S. Application Data
(63) Continuation-in-part of application No. 13/654,132, filed on Oct. 17, 2012, now Pat. No. 9,196,104.
Application No. 13/654,132 is a continuation-in-part of application No. 13/415,365, filed on Mar. 8, 2012.
(60) Provisional application No. 61/453,737, filed on Mar. 17, 2011.

(51) Int. Cl. G07C 9/00

(52) U.S. Cl. CPC G07C 9/00007; G07C 2009/00769

(57) ABSTRACT

A system may include a lock assembly that includes a lock, lock wireless communications circuitry, and a lock controller switchable between lock controller enrollment and operational modes. A remote device may include remote access wireless communications circuitry, and a remote access controller switchable between remote access controller enrollment and operational modes. The remote access controller, when in the enrollment mode, pairs the remote device with the lock assembly, and when in operational mode and paired, transmits a command. The lock controller may, when in the enrollment mode, determines whether the remote device is in the enrollment mode and within a threshold distance from the lock assembly less than a communication distance therebetween, and pairs with the remote device based upon being in the enrollment mode and within the threshold distance, and, when the lock controller is in the operational mode, switch the lock based upon the command.

### TECHNICAL FIELD

The present invention generally relates to access control systems, and more particularly, to passive keyless entry control systems.

### BACKGROUND

A passive keyless entry (PKE) system offers an increased level of convenience over a standard lock and key, for example, by providing the ability to access a secure building or device without having to find, insert, and turn a traditional key. A user may simply approach a locked PKE lock and with little if any pause or interaction, the lock grants this user access if they are carrying an authorized token.

A PKE system is currently used in an automotive application and may offer increased convenience by identifying drivers and unlocking the car as they approach. Automotive access is traditionally given by inserting a key into the lock or by pushing buttons on a traditional remote keyless entry (RKE) system. In contrast, a PKE system grants access with reduced user interaction through the use of a token carried by the driver.

Several technical challenges have been encountered during the engineering of a radio frequency (RF) PKE system, for example, for use in a residential lock. The desired basic perceived behavior of the PKE system in a residential application may be as follows: 1) the user approaches and touches the lock; 2) the lock authenticates the user with a reduced delay; 3) the lock unlocks; 4) the lock may not operate if the authorized user is outside a desired range and the lock is touched by another, unauthorized, user; 5) the lock may not operate if the authorized user is on the inside of the house, and the lock is touched on the outside by an unauthorized user; and 6) when an authorized user revokes a key from another user or a remote access device needs to be replaced, it may be revoked and confirmed within a few seconds.

Indeed, as will be appreciated by those skilled in the art, with respect to the above desired basic perceived behavior of the PKE system in a residential application, primary challenges to be addressed include items 2 (speed), 4 (distance), 5 (location), and 6 (timely revocation). Accordingly, it may be desirable to improve authentication speed, proximity measurement, and power consumption, for example.

### SUMMARY

A wireless access control system for a door may include lock assembly carried by the door. The lock assembly may include a lock, lock wireless communications circuitry, and a lock controller coupled to the lock and the lock wireless communications circuitry and switchable between a lock controller enrollment mode and a lock controller operational mode. The wireless access control system may also include a remote access device remote from the lock. The remote access device may include remote access wireless communications circuitry, and a remote access controller coupled to the remote access wireless communications circuitry and switchable between a remote access controller enrollment mode and a remote access controller operational mode. The remote access controller may be configured to, when in the remote access controller enrollment mode, communicate with the lock controller for pairing the remote access device with the lock assembly. The remote access controller may, when in the remote access controller operational mode and paired with the lock assembly, cooperate with the remote access wireless communications circuitry to wirelessly transmit a remote access command. The lock controller may be configured to, when the lock controller is in the lock controller enrollment mode, determine whether the remote access device is in the remote access controller enrollment mode, and determine whether the remote access device is within a threshold distance from the lock assembly less than a communication distance between the lock wireless communications circuitry and the remote access wireless communications circuitry. The lock controller may also be configured to pair with the remote access device based upon the remote access device being in the remote access controller enrollment mode and being within the threshold distance from the lock assembly, and, when the lock controller is in the lock controller operational mode, switch the lock between locked and unlocked positions based upon wirelessly receiving, via the lock wireless communications circuitry and the remote access device wireless communications circuitry, the remote access command. Accordingly, the remote access device and the lock assembly may pair more easily, for example, based upon being within a threshold distance.

The lock assembly may have an inside face and an outside face. The lock controller may be configured to pair with the remote access device when the remote access device is adjacent the inside face of the lock assembly and within the threshold distance thereto.

The lock assembly may include an inside directional antenna directed from the inside face and an outside directional antenna directed from the outside face. The lock controller may be configured to determine when the remote access device is adjacent the inside face based upon the inside and outside directional antennas, for example.

The lock assembly may further include an input device configured to switch the lock controller to the lock controller enrollment mode. The input device may be accessible from the inside face, for example.

The lock assembly may also include an input device coupled to the lock controller. The lock controller may be configured to un-pair the remote access device from the lock assembly based upon activation of the input device for a threshold time period. The lock controller may also be configured to determine whether another remote access device is paired with the lock assembly and pair the remote access device to the lock assembly based upon the input device when the lock assembly is paired to the another remote access device, for example.

The remote access device may include a housing carrying said remote access wireless communications circuitry and said remote access controller, and a display carried by said housing and coupled to said remote access controller. The remote access controller may be configured to display on said display an application for switching from the remote access device operational mode to the remote access device enrollment mode.

The remote access device may include a fob housing carrying said remote access wireless communications circuitry and said remote access controller and at least one input device carried by said fob housing and coupled to said remote access controller. The remote access controller may be configured to switch from the remote access device operational mode to the remote access device enrollment mode based upon said input device.

A method aspect is directed to a method of pairing a lock assembly and a remote access device in a wireless access control system for a door. The method may include using the remote access controller to, when in the remote access controller enrollment mode, communicate with the lock controller for pairing the remote access device with the lock assembly, and when in the remote access controller operational mode and paired with the lock assembly, cooperate with the remote access wireless communications circuitry to wirelessly transmit a remote access command. The method may also include using the lock controller to, when the lock controller is in the lock controller enrollment mode, determine whether the remote access device is in the remote access controller enrollment mode, determine whether the remote access device is within a threshold distance from the lock assembly less than a communication distance between the lock wireless communications circuitry and the remote access wireless communications circuitry, and pair with the remote access device based upon the remote access device being in the remote access controller enrollment mode and being within the threshold distance from the lock assembly. The method may also include using the lock controller to, when the lock controller is in the lock controller operational mode, switch the lock between locked and unlocked positions based upon wirelessly receiving, via the lock wireless communications circuitry and the remote access device wireless communications circuitry, the remote access command.

### BRIEF DESCRIPTION OF THE DRAWINGS

FIG. 1 is a schematic diagram of a wireless access system according to the present invention.

FIG. 2a is a perspective view of a lock constructed in accordance with the invention.

FIG. 2b is a perspective view of a lock constructed in accordance with another embodiment of the invention.

FIG. 3a is a top plan view of a remote access device constructed in accordance with the invention as a key.

FIG. 3b is a front plan view of a remote access device constructed in accordance with yet another embodiment of the invention as an application for a cell phone.

FIG. 4 is a front plan view of a home-connect plugin of the wireless access system constructed in accordance with the invention.

FIG. 5 is a schematic diagram of the communication between the components of the wireless access system in a typical residential system layout in accordance with the invention.

FIG. 6 is a flow chart of operation of the wireless access system in accordance with the invention.

FIG. 7 is a schematic diagram of the communication between the components of the wireless access devices in accordance with another embodiment of the invention having an outwardly facing antenna, and an inwardly facing antenna.

FIG. 8 is a perspective view of a lock containing a visual condition indicator constructed in accordance with the invention.

FIG. 9 is a perspective view of a lock with a visual condition indicator constructed in accordance with another embodiment of the invention.

FIG. 10 is a perspective view of a lock with a visual condition indicator constructed in accordance with another embodiment of the invention.

FIG. 11 is a perspective view of a lock with a visual condition indicator constructed in accordance with another embodiment of the invention.

FIGS. 12a-12d are a flow chart showing a method for replacing one remote access device with another in accordance with the invention.

FIG. 13 is a flow chart for operation of the inwardly facing antenna and outwardly facing antenna in accordance with the invention.

FIG. 14 is a schematic diagram of a wireless access control system for a door according to an embodiment of the present invention.

FIG. 15 is a schematic block diagram of the wireless access control system of FIG. 14.

FIG. 16 is a flow diagram illustrating an exemplary method of pairing the lock assembly and remote access device of the wireless access control system of FIG. 15.

FIG. 17 is a schematic block diagram of the wireless access control system according to another embodiment.

FIG. 18 is a flow diagram illustrating an exemplary method of pairing the lock assembly and remote access device of the wireless access control system of FIG. 17.

### DETAILED DESCRIPTION

The present description is made with reference to the accompanying drawings, in which various embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

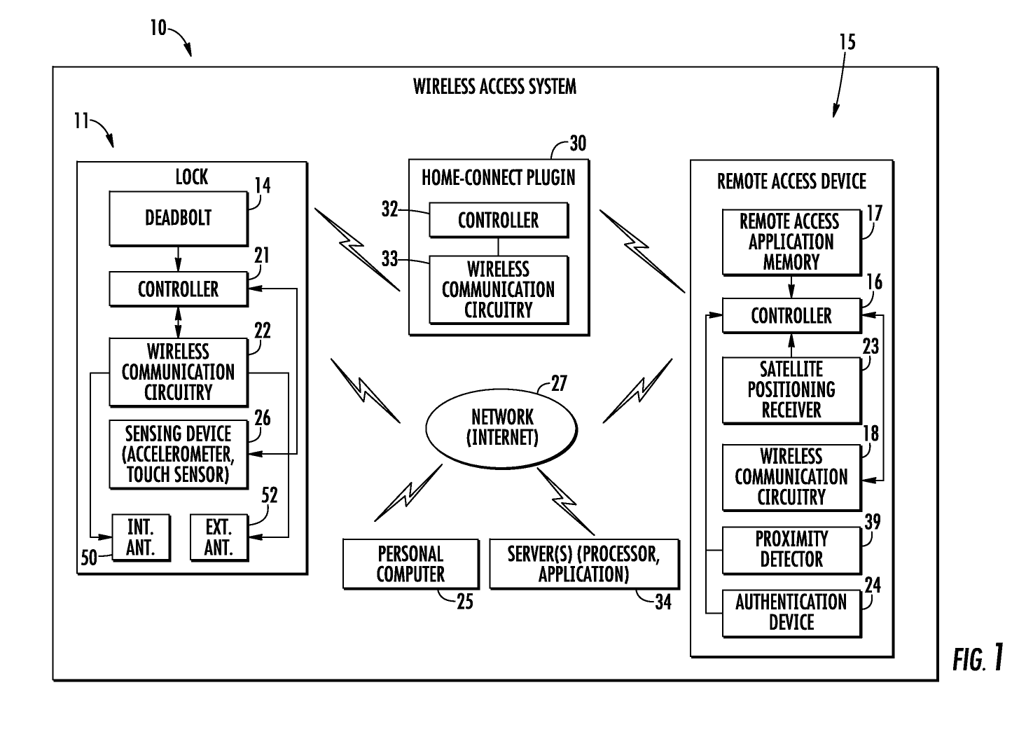

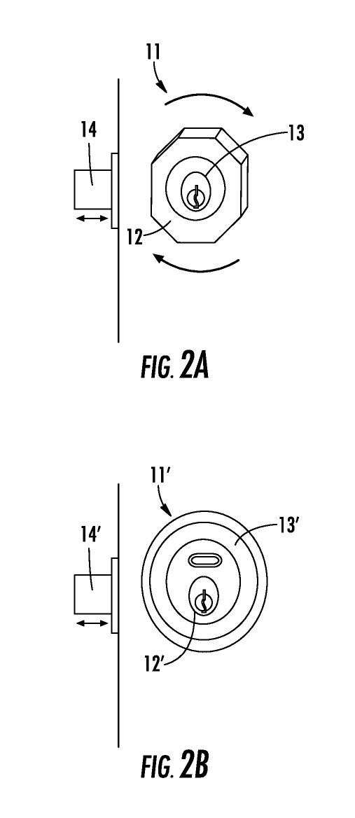

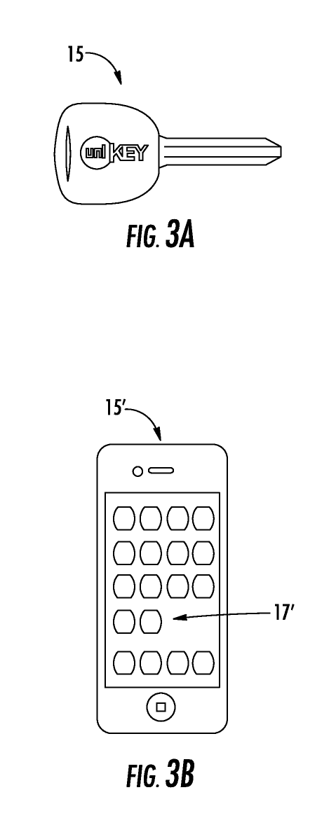

Referring to FIGS. 1, 2a, and 2b, a wireless access system 10, for example, a PKE system, includes a lock 11. The lock 11 may be installed in a standard deadbolt hole and may be battery powered, for example. The lock 11 may be a human controlled (keyed) lock, for example (FIG. 2a). The lock 11 includes an outer cylinder 12 that rotates freely around a standard key cylinder 13. When engaged, the cylinder 13 is linked to a deadbolt 14, thus giving the user control to extend or retract the deadbolt utilizing their key. The lock 11 includes a controller 21 or processor and wireless communication circuitry 22 for wireless communication which as will be discussed below, enable remote access device 15 to operate lock 11.

Alternatively, in another embodiment, the lock 11′ may be motor powered (FIG. 2b). When a user is in sufficiently close vicinity or touches anywhere on the lock 11′, the deadbolt 14′ is driven by the motor (not shown) to open the lock for authorized users having the remote access device 15. Of course, the lock 11 may be another type of lock or locking mechanism and may be installed in any access point, for example.

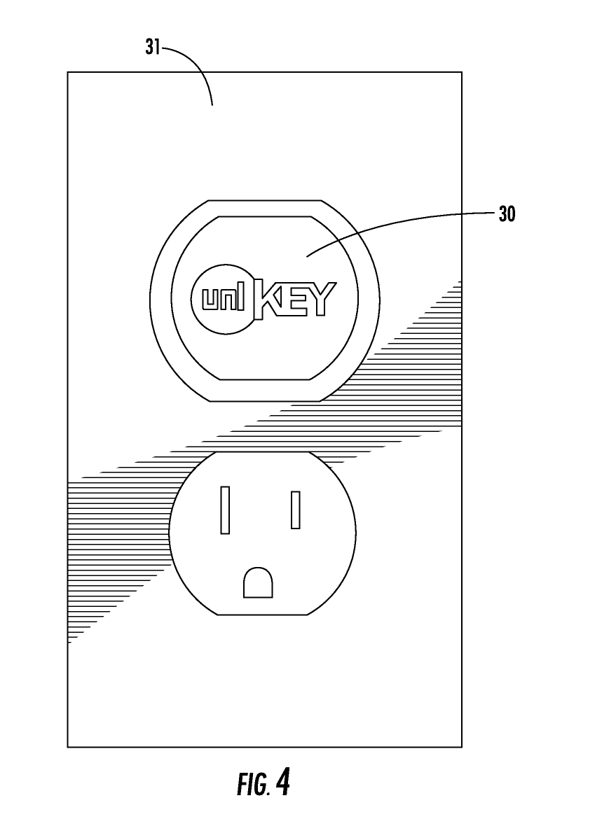

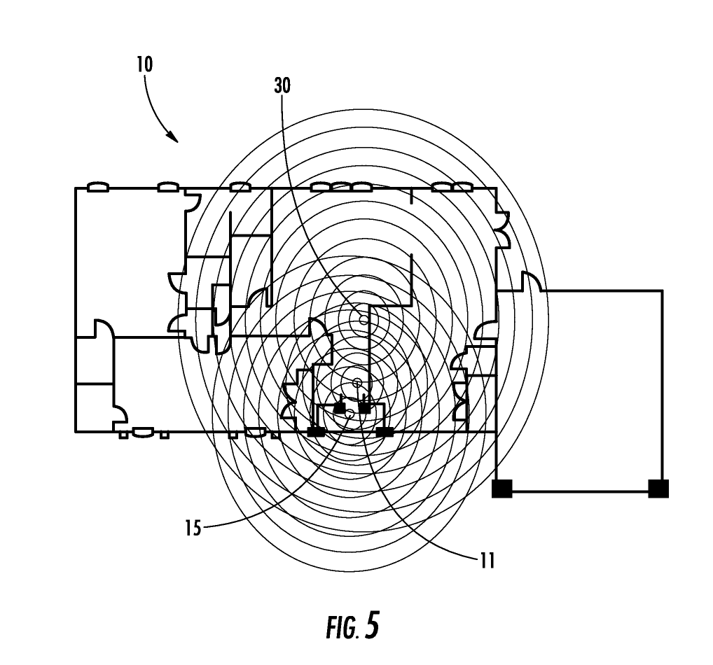

Referring now additionally to FIG. 3, the wireless access system 10 includes a remote access device 15. The remote access device 15 is advantageously a key or token configured to control the lock 11. In particular, the remote access device 15 may be a standard key including a remote controller 16 for controlling lock 11 and remote wireless access electronics coupled thereto (FIG. 3a). Remote access device 15 also includes wireless communication circuitry 18 for sending and receiving signals. In a preferred non-limiting example, the signal is a Bluetooth signal.

Alternatively, or additionally, the remote access device 15 may be a mobile wireless communications device, such as, for example, a mobile telephone that may include the remote wireless access electronics described above cooperating with an application 17′ stored in memory 17 (FIG. 3b). The application 17′ may be configured to send a signal to provide access and control over the lock 11′, for example. Of course, more than one remote access device 15′ may be used and may be another type of remote access wireless device, for example, a wireless FOB without the mechanical key, as will be appreciated by those skilled in the art.

Referring now additionally to FIG. 4, the wireless access system 10 also includes a home-connect plugin 30. A typical mains power outlet 31 is shown, with the home-connect plugin 30 plugged-into it. The home-connect plugin 30 includes a home-connect controller 32 and associated wireless communication circuitry 33 cooperating therewith and configured to communicate with the lock 11, and the remote access device 15.

The home-connect plugin 30 may also be part of a wireless local area network (WEAN) connectivity, for example, Wi-Fi connectivity, to link it to an off-site web-based server 34, for example. This advantageously enables the lock 11 to receive near real time updates for adding or removing users, one-time access, extended access or specific timed access, and other connectivity related updates and functions, as will be appreciated by those skilled in the art. Additional services may be selectively provided via the Internet using the WLAN connectivity provided by server 34, for example. While the home-connect plugin 30 is described herein as a plugin device, it will be appreciated by those skilled in the art that the functionality of the home-connect plugin 30 may be embodied in any of a number of form factors, for example.

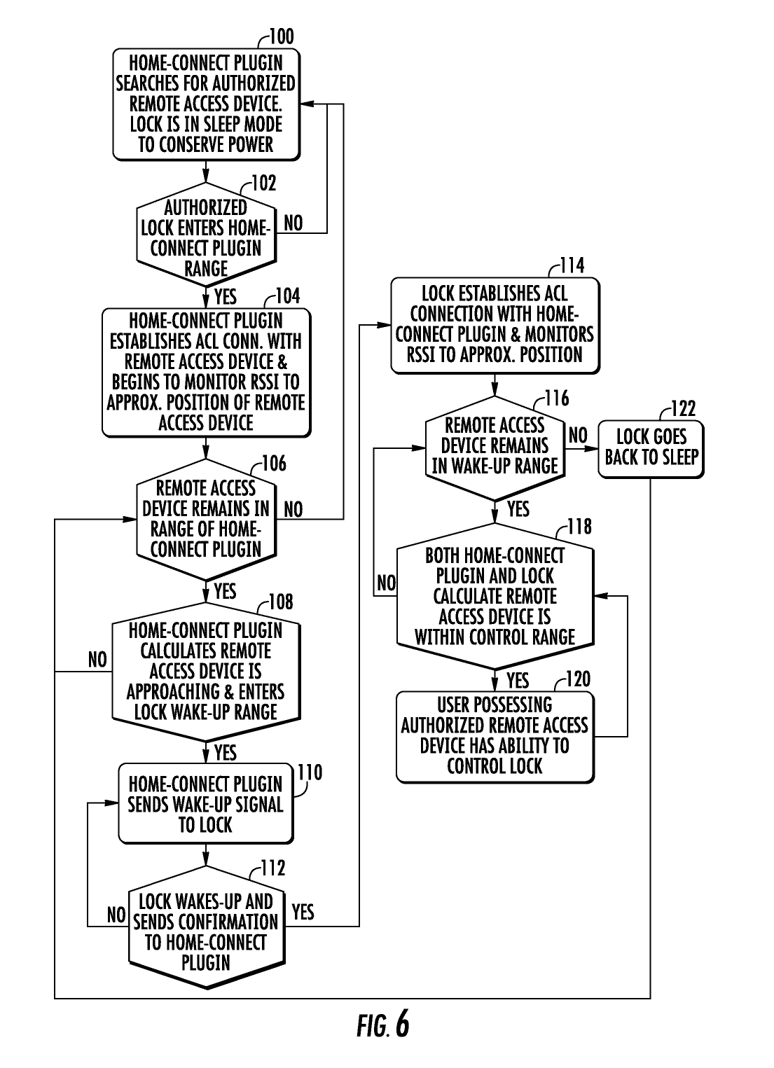

Referring now additionally to FIG. 5, a typical residential setup example of the wireless access system 10 is illustrated. As described above with respect to FIG. 4, the home-connect plugin 30 is typically plugged-in to the mains power outlet 31, at a location in relatively close proximity, sufficient to communicate therewith, to the lock 11, which may be installed on the front door, for example. The remote access device 15 approaches from the outside of the home. Both the home-connect plugin 30 and lock 11 are configured to communicate with the remote access device 15 independently or simultaneously, as will be described below and appreciated by those skilled in the art.

The home-connect plugin 30 may be configured to approximately determine the position of the remote access device 15. In a preferred non-limiting embodiment, the home-connect plugin 30 periodically sends a signal to communicate with a remote access device 15. When remote access device 15 is within range to receive the signal, remote access device 15 outputs a return signal to home-connect plugin 30. Lock 11 may also receive the signal from remote access device 15. By determining a received signal strength indication (RSSI). For example, when an algorithm of the home-connect plugin 30 determines that the remote access device 15 is approaching and is within a defined range.

In one non-limiting exemplary embodiment, lock 11 is in a hibernation or low power level state. Upon determining that the remote access device is within a predetermined distance, the home-connect plugin may send a wakeup signal to the lock 11. In this way, home-connect plugin 30 may be configured to have an extended range capability, for example, 100 or more meters. The lock 11 has a smaller range, for example, of about 10 meters, but may be greater in some cases.

Therefore, the home-connect plugin 30 may communicate with the remote access device 15 before the lock 11. Thus, the home-connect plugin 30 may send a signal to the lock 11 to wake up and start communicating with the remote access device 15 to save battery life, for example. By causing remote access device 15 and lock 11 to communicate only in response to a signal from home-connect plugin 30, the battery life of lock 11 and remote access device can be extended.

Additionally, the home-connect plugin 30 may establish a communication link with the remote access device 15 in advance, for example, thus increasing the speed of the authentication process to create little if any perceived delay for the user. Once the lock 11 is woken up by the home-connect plugin 30 and connected to the remote access device 15, both the home-connect plugin and the lock track the RSSI of the remote access device until the algorithm determines it is within a defined accessible range from lock 11. Both the home-connect plugin 30 and the lock 11 gathering RSSI data together may utilize this data in an algorithm to determine the position of the remote access device 15 with greater accuracy than either the home-connect plug in 30 or lock 11 alone. Once the remote access device 15 is within the determined accessible distance, the home-connect plugin 30 grants remote access device 15 access control to the lock 11. More than one home-connect plugin 30 may be used in some embodiments for more accurate position determining, and to increase authorized user capacity and overall speed of the wireless access system 10.

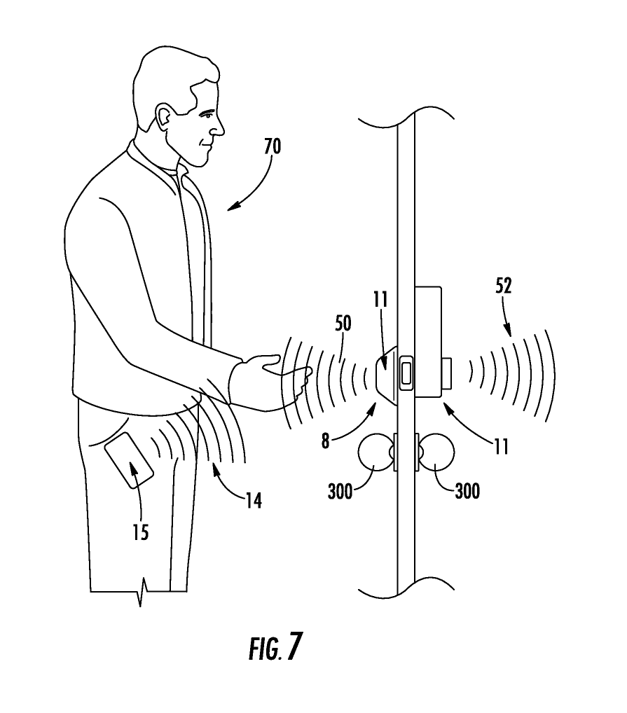

Operation of the wireless access system 10 will now be described with reference additionally to the flowchart in FIG. 6. The lock 11, may initially be in a sleep mode to conserve battery power, for example. The home-connect plugin 30 is typically powered on and searching for authorized remote access devices 15, i.e. token(s), the standard key, and/or the mobile wireless communications device, in range in a step 100. In one preferred non-limiting embodiment, authorization is established by syncing the Bluetooth identifier of remote access devices 15 and home-connect plugin 30 as known in the art. The home-connect plugin 30 establishes an asynchronous communication link, (ACL) connection. In this way the system is self authorizing at it only recognizes components with which it has established a connection.

The authorized remote access device 15 enters the home-connect plugin 30 broadcast range in a step 102. Once the home-connect plugin 30 finds an authorized remote access device 15 in range, it establishes connection in a step 104 and begins to monitor the RSSI of the return signal from remote access device 15 to estimate its position.

In a step 106, it is determined whether remote access device 15 remains in range of the home-connect plugin 30 if not the process returns to step 100 to begin again. If yes, then home-connect plugin 30 calculates whether remote access device 15 is approaching and whether it enters the lock wake-up range in step 108. If not, step 106 is repeated. Once the home-connect plugin 30 estimates that the remote access device 15 has entered the defined wake-up range in a step 108, it sends a wake-up and connection signal to the lock 11 in a step 110.

In a step 112 it is determined whether lock 11 wakes up and sends confirmation to home-connect plugin 30. If not, the wake-up signal is repeated in step 110. Once the lock 11 wakes up, it also establishes a low level connection with the remote access device 15 in a step 114, and begins to monitor the RSSI of the remote access device 15 or devices if there are more than one. Both the home-connect plugin 30 and the lock 11 are monitoring RSSI to more accurately determine the position of the remote access device 15 in a step 118. This computing may be performed by a processor or controller 32 included within the home-connect plugin 30, the controller 21 within lock 11, or both. The home-connect plugin 30 and the lock 11 determine whether the remote access device is within the determined accessible distance in step 116. It is determined whether the home-connect plugin 30 and lock 11 calculate the remote access device 15 is within the control range. If not, the determination is again made in step 116; if yes, then the user is granted authorization to the lock 11, and the deadbolt 14 becomes controllable in a step 120, either extending or retracting per the user's action.

If the remote access device 15 is not within the wake-up range of lock 11, then lock 11 goes back to sleep or a low power mode, in a step 122.

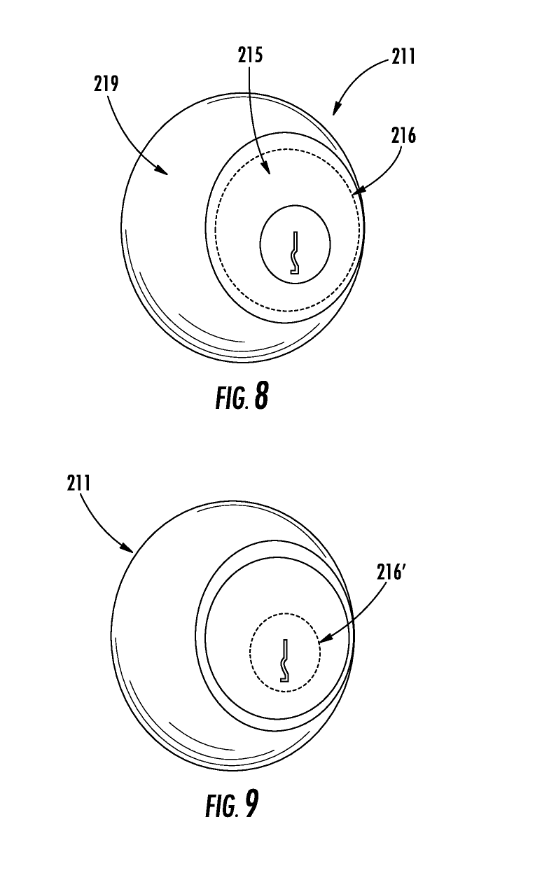

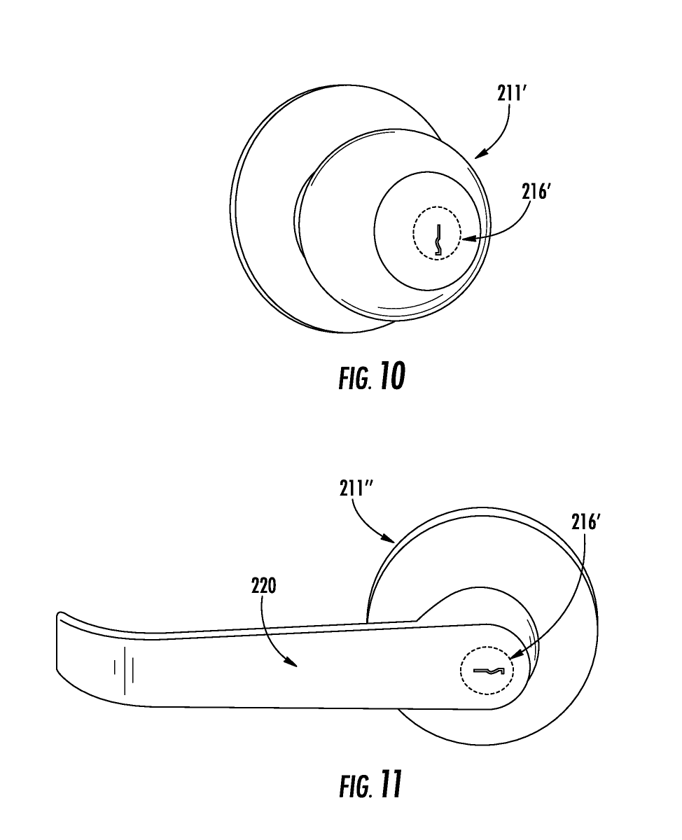

Additional and/or alternative functions of the wireless access system 10 will now be described. Reference is now made to FIGS. 8-11 wherein a lock constructed and operated in accordance with another embodiment of the invention is provided. Like numbers are utilized to indicate like structure. The primary difference in this embodiment being the inclusion of the visual indicator at an easily and readily seen position on the lock to indicate a system condition to the user as they approach the lock.

As seen in FIG. 8 a deadbolt lock 211 includes a visual indicator 216. In a preferred but non-limiting embodiment, visual indicator 216 is a selectively controllable light in the form of a circle having a diameter substantially equal to the diameter of the cylinder of deadbolt lock 211. In a preferred embodiment, visual indicator 216 is a light emitting diode (LED) formed as a circular light pipe. In a preferred but non-limiting embodiment, visual indicator 216 is capable of indicating two or more visual conditions such as two or more colors, static versus flashing, in illuminate or non-illuminate, in order to indicate at least two distinct conditions.

Visual indicator 216 may be controlled by either one of onboard controller 21 or home-connect plugin controller 32. In a preferred embodiment, controller 21 which controls lock 211 is in communication with and controls audiovisual indicator 216.

In this way, when lock 211 determines that the remote access device is within a determined accessible distance such as in step 116 above, the state of audiovisual indicator 216 is changed either from dormant to illuminated, from a first color such as red indicating locked, to a second color such as green indicating open, or from a static state color to a flashing illumination. What is required is a change in condition/state of the illuminating device in response to a recognition that the remote access device is within a predetermined distance to allow control of the lock 211.

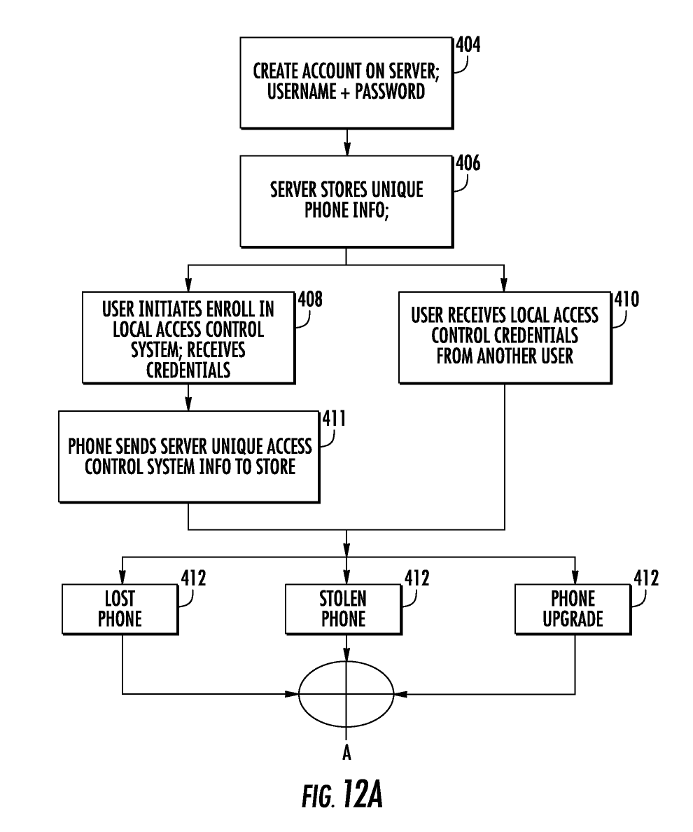

Positioning a visual indicator 216 at the circumference of the face of the lock 211 is given by way of example only, as shown in FIG. 9. Visual indicator 216′ may merely encircle the actual key hole for the lock as seen in FIG. 10. In a doorknob spring lock embodiment, a doorknob 211′ includes visual indicator 216′ which surrounds the key hole. Lastly, in a lever embodiment 211″ as shown in FIG. 11, having a handle 220 also includes a visual indicator 216′ surrounding the key hole.

Furthermore, visual indicator 216 may indicate that a lock is in a lock/unlock state, is accessible to be opened utilizing touch sensor 26, as described above, but may also be used to indicate an error in operation utilizing a third type of visual indicator (color yellow flashing at a different rate), that lock 211 is capable of being programmed or is in the process of being programmed. Different indicators as expressed by visual indicator 216 may even indicate different steps in a lock or unlocking process, or as confirmation of the completion of different steps during a programming process.

In addition to informing the user that they are in the control range, visual indicator 216 can change its indicating state by a single touch sensed at touch sensor 26. By way of example, the user touches lock 211 at a position 215 or 219 to unlock lock 211 and visual indicator 216 turns green. The user may again touch lock 211 to lock lock 211 and changing the state exhibited by audiovisual indicator 216 from green to red.

In another embodiment, with respect to an independent function, plugin 30 may notify lock 10 at a low energy level that the home-connect plugin 30 has lost power, the lock 11 may be configured to have a change of status to wake up in the absence of the signals from plugin device 30, or to be woken up by a user's touch and approximately determine the position of the user by itself, as well as authenticate the user in a manner similar to that described in connection with plugin device 30. In another embodiment, plugin 30 continuously pings lock 10 at a low energy level and if plugin 30 goes offline, lock 11 may be configured to have a change of status to wake up in the absence of the signals from plugin device 30, or to be woken up by a user's touch and approximately determine the position of the user by itself, as well as authenticate the user in a manner similar to that described in connection with plugin device 30. In an embodiment in which the remote access device is a smart phone, tablet, or similar device, home-connect plugin 30 may also request the user to verify their access control request by prompting them for an action or code on their remote access device 15, for example, via a display on their mobile wireless communications device.

The wireless access system 10 may include a calibration feature. More particularly, a connection between the home-connect plugin 30 and the lock 11 may be used by the algorithm to calibrate the RSSI input to adjust for changes in environmental conditions, for example. In one non limiting example, plugin device 30 determines RSSI values for remote access device 15 over a number of distinct communications. It then determines a maximum average in range value in which communication between plugin device 30 and remote access device 15 occurs and a minimum average in range value at value in which communication between plugin device 30 and remote access device 15 occurs. In this way, the distances at which plugin 30 begins communicating with remote access device 15 self adjusts as a function of local conditions.

The wireless access system 10 may include an additional positioning input feature. The remote access device 15 may have an accelerometer which can be utilized to determine the orientation of the remote access device 15, which can be transmitted to system 10, for example by Bluetooth low energy. This orientation information can be utilized in conjunction with the received signal strength to better determine the remote access device 15 position. This is useful as received signal strength can vary based on orientation even if the position of the device 15 does not change.

In a process to revoke a key where the key is a smart phone, tablet or the like, once a user decides to revoke a key code, the user may send a termination request to home-connect plugin 30 or to the remote access device key 15′ being revoked. If there is no response, the request is broadcast to users, for example, all users, in the “approved” network (i.e. users enrolled in the same lock). The request is stored in the background on their respective keys. Then when any authorized user is in range of the lock 11, the key code is revoked from the lock, denying access to the revoked user.

The wireless access system 10 may also include a computing device 25, for example, a personal computer at the user's residence for use in the revocation process. The computing device 25 may include circuitry for wirelessly communicating with the home-connect plugin 30, remote access device 15, and/or lock 11 for revoking the permission. For example, the computing device 25 may include Bluetooth communications circuitry, for example. Other devices and communications protocols may be used in the revocation process.

While the wireless access system 10 is described herein with respect to a door, the wireless access system may be used for access control or protection of, but not limited to, appliances, heavy machinery, factory equipment, power tools, pad locks, real estate lock-boxes, garage door openers, etc., for example. Alternative remote access device 15 embodiments may include a pen, watch, jewelry, headset, FDA, laptop, etc., for example. The wireless access system 10 may be used to protect other devices or areas where it may be desired to restrict access.

With respect to power conservation and increased security methods for the remote access device 15, and more particularly, a mobile wireless communications device 15′, for example, that may include the remote access application and a global positioning system (GPS) receiver 23, the GPS receiver may be used to track the location relative to the lock's position and enable communication by remote access device 15 only when within range. If the remote access device 15, i.e. mobile wireless communications device 15′ is outside the range, as determined by the GPS receiver 23, it may not transmit, go into sleep mode or turn off. Additionally, or alternatively, the location of the mobile wireless communication device 15′ may be determined via triangulation with wireless service provider base stations or towers, for example.

Alternatively, or additionally, the remote access device 15 or mobile wireless communications device 15′ may wake up, determine a position, calculate a fastest time a user could be within range of the lock 11, then wake up again at that time and recalculate. When the user is within the range, it may enable the remote access application 17, and, thus communication for authentication or other purposes.

The wireless access system 10 may be used to augment multi-factor authentication, e.g. use with a biometric identifier, personal identification number (PIN) code, key card, etc. The wireless access system 10 may also allow simultaneous multiple authentication of remote access device, for example, mobile wireless communications devices. More particularly, the wireless access system 10 may require a threshold number of authorized remote access devices 15 to be present at a same time for authentication to succeed.

The wireless access system 10 advantageously may provide increased security, for example. More particularly, the wireless access system 10 may force the user to authenticate in addition to authorization, via the remote access device 15 before the door can be opened. For example, the remote access device 15 may include an authentication device 24 for authentication via a biometric, password, PIN, shake pattern, connect-the-dots, or combination thereof, for example, prior to accessing the lock 11. In the case of the remote access application 17 on a mobile wireless communications device, for example, the application may have multiple security levels to enable these features, as will be appreciated by those skilled in the art.

With respect to security features, by using proximity sensors, switches, or the like, the wireless access system 10 may indicate whether a user locked the door, for example. When a user locks the door, for example, the remote access application 17 may log “Lock” with a time stamp so that it may be tracked and checked on the remote access device 15, i.e. the mobile wireless communications device, for example. The wireless access system 10 may include a sensing device 26 for example, an accelerometer to track door openings, for example. Based upon the accelerometer, data may be provided through the application or via the Internet or other network, for example. The sensing device 26 may be another type of device, for example, a touch sensor.

In one advantageous security feature, when the door is opened, or an attempt is made to open the door, which may be detected by the accelerometer 26 or other door opening determining methods, as will be appreciated by those skilled in the art, known, and even previously revoked, remote access devices 15 in range and/or discoverable devices, may be recorded along with a time stamp. This may capture an unauthorized user, for example.

Another advantageous feature of the wireless access system 10 may allow authorized visits, for example. More particularly, an authorized visit may be enabled by a 911 dispatcher or other authorized user to allow special or temporary access by the smart phone of a normally unauthorized user, for example. The wireless access system 10 may keep a log/audit trail. Approval may be granted by trusted a friend or special authority, for example, emergency medical services, a fire department, or a police department.

The wireless access system 10 may also include a security feature whereby when a threshold time has elapsed, the wireless access system may ignore a remote access device 15 in range. This advantageously reduces or may prevent unauthorized access that may occur from leaving a remote access device 15 that is authorized inside near the door. A timeout function (via a timer, not shown) may additionally be used in other undesired entry scenarios. The wireless access system 10 may also log all rejected pairing attempts, as will be appreciated by those skilled in the art.

The wireless access system 10 may also include a revocable key security feature. For example, the wireless access system 10 may include both revocable and non-revocable keys. If, for example, the wireless access system 10 is unable to access the server 34 to verify keys, for example, the wireless access system may force the application 17 on the remote access device 15, for example, to check the servers. If the wireless access system 10 is unable to connect or verify the keys, access is denied.

For example, the revocable key feature may be particularly advantageous to keep an old boyfriend, for example, who is aware that his key is being revoked from being able to turn off his remote access device 15 so that the key is not deleted. However, a wireless connection for the remote access device 15 may be a prerequisite to access in some instances.

As will be appreciated by those skilled in the art, the wireless access system 10 has the ability to transfer a key from one remote access device 15 to another with the remote access application 17, for example. It may be desired that these keys be revocable in some configurations. However, if the remote access device 15 with the key to be revoked is not accessible via the network 27, then revocation may not be guaranteed if the lock 11 is offline, for example. The wireless access system 10 advantageously addresses these challenges.

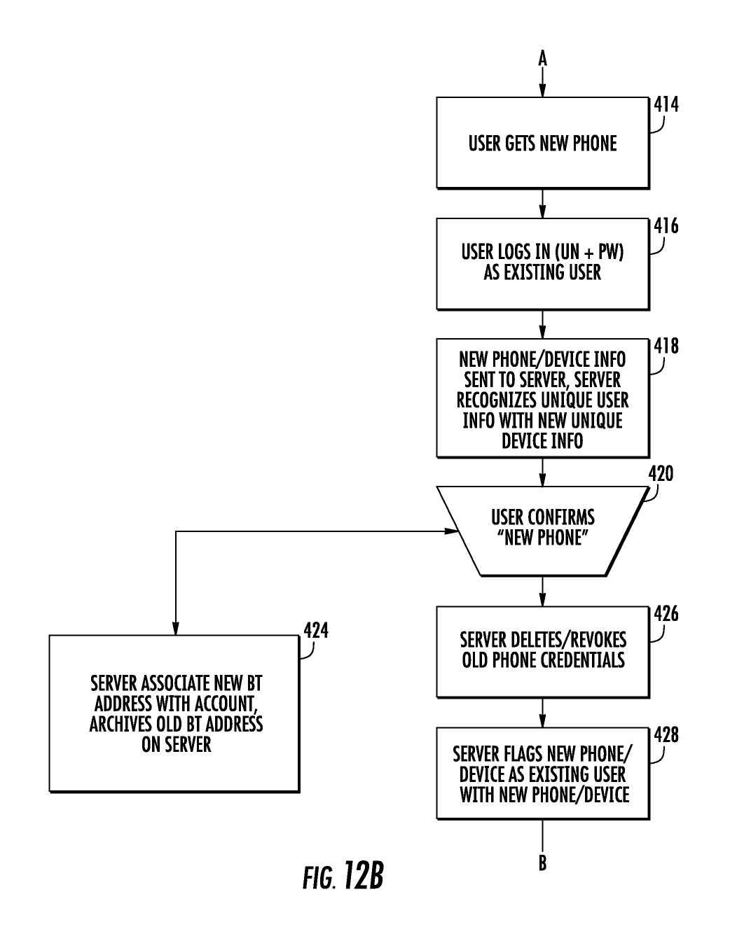

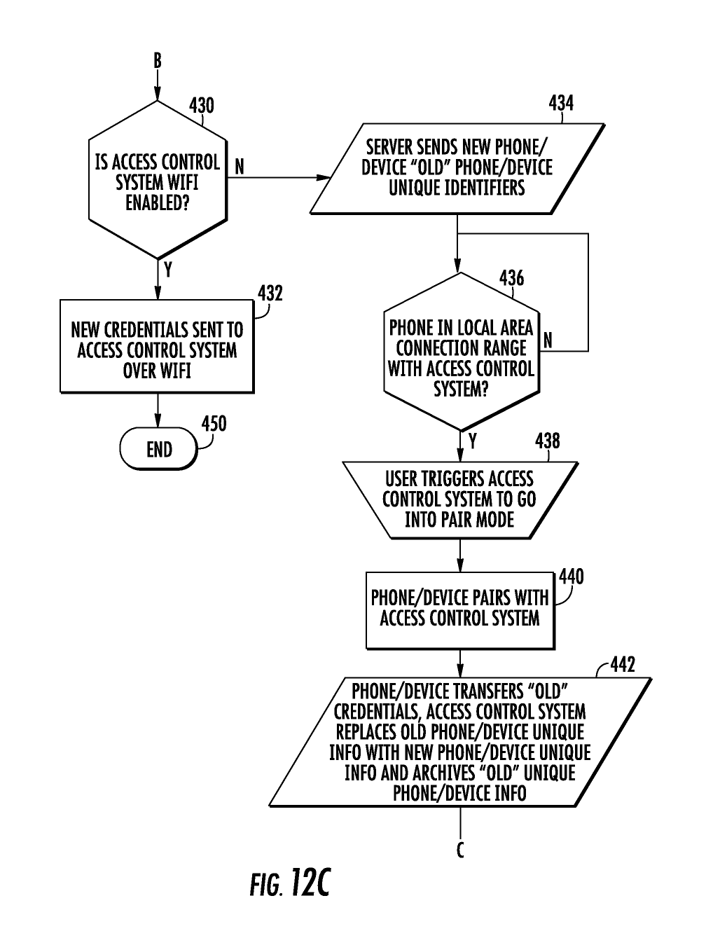

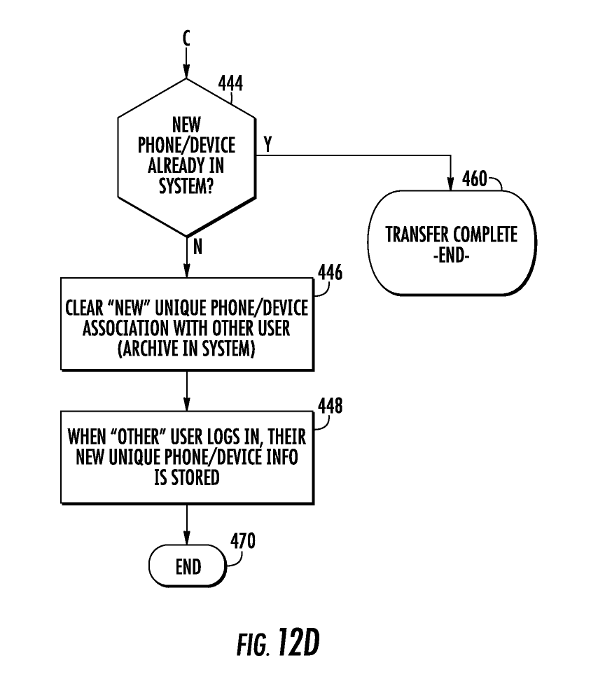

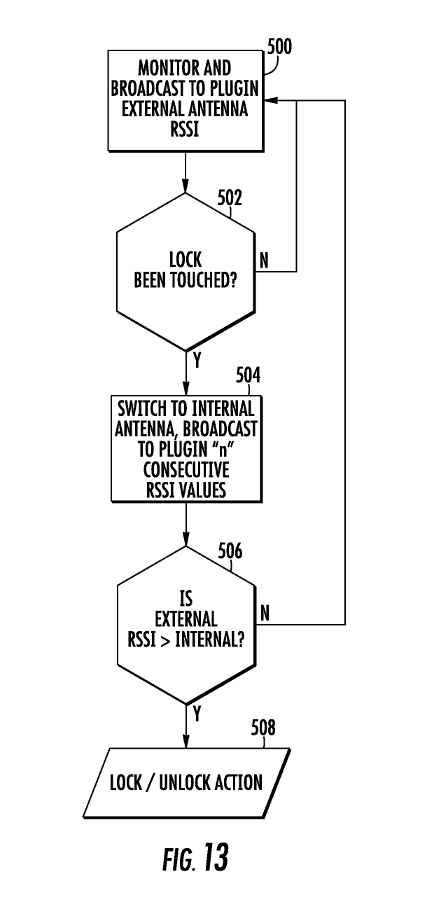

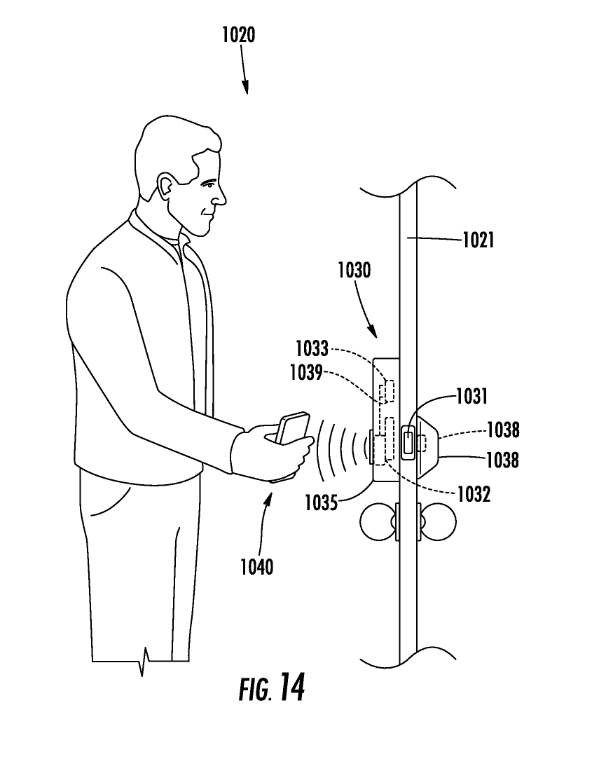

In addition, to adding or removing access, it is contemplated, particularly where the remote access device is a cell phone, that a user does not retain a remote access device forever. They may be lost, stolen, or changed for an upgrade by way of example and the replacement device must be paired with the lock. Reference is now made to FIGS. 12 a-12 d in which an embodiment of the invention for changing the remote access device of a particular user is provided. In a step 404, at the very beginning of the initialization for a new user of the system; to join a phone remote access device 15 by way of non-limiting example, to the system, an account is created on server 34, either a local server such as the processor discussed above, or in the preferred non-limiting embodiments, remote access server 34. An account ID and at least a user name and password are stored at server 34 in a step 404. Server 34 also stores phone identification information such as a bluetooth address as communicated by the phone, a phone number and any other phone identification information such as SIM card information, or the like in a step 406.

In a step 408, the user initiates the local access control system 15 as discussed above by communicating with either the controller of home-connect plugin 30 or lock 11. As discussed above in step 410, the remote access device 15 may receive its access control information or “key” as transferred from another remote access control device 15. In a step 411, the remote access device 15 sends the paired lock information to server 34 so that server 34 now maps to this particular account, the phone identifier, the bluetooth information, and the lock information. The server, either local server 34 or a remote server communicating across the internet, stores the access control system identification information, the pairing of the pass key, the (“K”) code and the like, which matches the remote access device 15 to the remote access control system, and the types of control and operation. The system then operates as discussed above.

However, as often occurs as in a step 412, the remote access device (particularly a phone) is either lost, stolen or changed. However, each phone has its own unique bluetooth address and other phone identification information, and therefore, in a preferred embodiment, each remote access device 15 has its own identifier recognizable by lock 11 and home-connect plugin 30. System 10 requires an ability to equally recognize users with new remote access devices. Because the unique bluetooth identifier of each remote access device 15 is used as part of the recognition and access algorithm in a preferred non-limiting embodiment as discussed above, a new remote access device 15 requires repairing with lock 11.

In step 414 a new remote access device 15, a phone in this non-limiting exemplary embodiment, having its own phone identification information such as a bluetooth address is obtained. Utilizing the phone, the user enters account login information to server 34 in a step 416. Server 34 utilizes the login information to determine that the new phone bluetooth address and phone identification is for an existing account, as the phone number travels with the communication in a step 418. Server 34 sends a message to the phone asking whether it is in fact a new phone in the step 420 and the user confirms the status of the new phone.

In a step 424, server 34 associates the new phone bluetooth address with the existing account and archives the old bluetooth address on server 34 At the same time, or immediately before or immediately after, in a step 426, server 34 revokes the old phone credentials (phone ID information, bluetooth address) from the account. Server 34 stores the new remote access device information associated with the existing account.

It is then determined in a step 430 whether or not the local lock system for that particular user is WiFi enabled. If yes, then in a step 432 the new credentials are sent to the local controllers 21, 16 over a WiFi network or other local communication network as the new credentials are paired with the lock 11, the process is ended in a step 450.

If the system is not WiFi enabled, then in a step 434 server 34 sends the unique identifiers of the old remote access device 15 to the new remote access device to be temporarily stored thereon. In a step 436 it is determined whether or not the remote access device 15 in the form of the phone is within local area connection range, i.e. within range to communicate with either one of controller 32 of the home-connect plugin 30 and/or controller 21 of lock 11. Step 436 is repeated until remote access device 15 is within range. Once within range, the user triggers the access control system to enter a pairing mode in a step 438 so that in this way, the lock 11 recognizes a local access device 15 and the user. Even though, it is not equipped to communicate with server 34, because of the use of the old phone identifying information, it knows it is communicating with a trusted remote access device 15. The phone (remote access device 15) pairs with the access control system in a step 440 and the phone transfers the old bluetooth address credentials to either control lock 16 or controller 21. In a step 442, system 10 updates the bluetooth address stored at lock 11 and home-connect plugin 30 with the new phone bluetooth address and phone identifier information and archives the old bluetooth address in a step 442.

In a step 444, it is confirmed whether the new phone is already in the system. If it is in the system, then the process ends in a step 460. If it is not in the system, then the processor 34 clears the new bluetooth address associated with another user so in step 446 that when the user logs in with their new bluetooth address the current remote access device information is stored in a step 448, in effect phone swapping. The process is then ended in a step 470.

For the purpose of enrolling an administrator, the first user, or other users, the system can utilize a tap proximity method as an alternative to a PIN or password. In the case of a newly installed system, the system may be vulnerable to unauthorized enrollment. It becomes convenient and secure to require the user to simply tap their device 15, that they wish to enroll, to the wall plugin unit 30 or the inside of the lock 11, to prevent outside unwanted users from enrolling in the system.

A proximity detection feature may be included in the wireless access system 10, and more particularly, the remote access device 15 may use a magnetic field sensor 39, such as, for example, a compass in mobile wireless communications device, as a proximity sensor to obtain a more uniform approach/departure distance calibration. A magnetic pulse or pulse sequence may be used in the lock 11 to illuminate a magnetic flux sensor in the remote access device 15 to establish proximity.

Additionally, the remote device 15, for example, a mobile wireless communications device or mobile telephone, may be qualified using both radio frequency (RF) and audio, for example. The remote access device 15 may be a source or sink of audio to help qualify proximity.

In another embodiment, as an alternative to a human driven lock, as noted above, a turn-tab (not shown) may be included that will “flip out” of the front of the lock 11 when pressed to allow the user to turn the lock on an un-powered deadbolt 14. It may be desirable that the surface area be no larger than a standard key, for example. The user pushes the turn-tab back into the lock face when done. The turn-tab may alternatively be spring loaded, for example.

In another embodiment, the turn-tab (not shown) may be added to a powered lock, for example the lock 11 described above. This is may be useful to help force ‘sticky’ locks, for example, as will be appreciated by those skilled in the art. This may also allow the user to give a manual assist to the motor in case of a strike/deadbolt 14 misalignment. This may also allow for operation in a low battery situation, for example. The turn-tab may be particularly useful in other situations.

Additionally, one of the deadbolts may have a traditional key backup as it may be needed for emergencies, for example, while the remaining deadbolts on a house may be keyless. This may eliminate the need to match physical keys on multiple deadbolts, and may reduce the cost for additional deadbolts.

The wireless access system 10 may also include an additional access feature. For example, with the home-connect plugin 30 connected to the Internet through server 34 and/or personal computer 25, for example, it may be possible to have the lock 11 unlock via a command from the wireless access system. In other words, the lock 11 could be opened for users who don't have a remote access device 15. More particularly, they could call a call center or service that could unlock the lock 11 via the Internet 27, for example, or via other wireless communications protocol. Also, an authorized user could provide this action as well. Additionally, fire/police could gain access by this method if the lock owner opts-in to this service. As will be appreciated by those skilled in the art, alternatively, a command could be sent from the remote access device 15.

The wireless access system 10 may also include an activation indication. For example, the remote access device 15 can signal the operator via an auditory tone, vibration or other indication when the lock is activated. This may help communicate actions to the user to reduce any confusion.

The wireless access system 10 may also include an additional security feature. For example, the wireless access system 10 may use an additional authentication channel, for example, via a WLAN, WiFi, or other communication protocol, either wired or wireless, with the remote access device 15. This may improve authentication and make spoofing considerably more difficult, as will be appreciated by those skilled in the art.

As another security feature of the wireless access system 10, if cell service and data service, for example, if the remote access device 15 is a mobile phone, are turned off, remote access application may consider this a threat related to key revocation and authentication may not be approved. Also, the lock 11 may include a radar device, or a radar device may be coupled adjacent the lock to detect the locations of the entrant by facing outward in its sweep to resolve inside/outside ambiguity, for example. If the radar does not detect an entrant, then by default the holder of the remote access device is inside and the lock is not activated. The radar may be enabled when the lock 11 is woken up by the home-connect plugin 30 to conserve power.

Reference is now made to FIGS. 5, 7 and 13 in which an embodiment of the invention having a lock 11 which includes an interior facing directional antenna 50 and a an external facing directional antenna 52 (schematically shown). Each is operatively coupled to wireless communication circuitry 22 to send signals to, and listen for signals from, remote access device 15. If interior facing directional antenna 50 communicates with remote access device 15, lock 11 and in turn system 10 determine that remote access device is inside the home, dwelling or structure. If exterior facing directional antenna 52 communicates with remote access device 15, system 10 determines that remote access device 52 is outside of the dwelling and operates as discussed above. Home-connect plugin 30 compares the signals from interior facing directional antenna 50 and exterior facing directional antenna 52 to confirm the location of remote access device 12 prior to enabling remote access device 15 to control lock 11. This prevents the door from unlocking each time someone within the structure passes by the lock.

During operation, as user 70 approaches lock 11, external antenna 50 communicates with remote access device 15 and its signal to determine an external RSSI in accordance with a step 500. As user engages lock 11 or an associated door knob, sensor 26 detects whether or not lock (or knob 300) has been touched in a step 502. If not, then step 500 is repeated and the external antenna RSSI is monitored.

If the lock 11 has been touched, then controller 21 at lock 11 switches the operation antenna to the use of an internal antenna 52 to broadcast to home-connect plugin 30 and determines a predetermined number of consecutive RSSI values. In a step 506 it is determined whether the outside RSSI is greater than the inside RSSI. if it is, then the system determines that the authorized user is outside the dwelling and lock 11 operates to either locked or unlocked in a step 508. If the outside RSSI is determined to be less than the inside RSSI in step 506, then the user 70 is inside of the dwelling and the process returns to step 500 where the outwardly facing antenna is utilized. This is important as the user would not want the system to be controlled from the outside by their access device 15 if they are on the inside. In other words, this use of both the interior and the exterior facing antennae, prevents the system from being fooled i.e., being unlocked by an unauthorized user on the outside if the authorized remote access device 15 is near the door on the inside.

In another embodiment, lock 11 may make use of sensor 26 to allow users not authorized to lock the passive key entry system 10, such as house guests, a service worker, or the like, which may receive permission to enter, but had been asked to lock the door as they leave. In one embodiment, the guest, service worker, or the like simply touches the lock 11 for an extended period of time greater than an inadvertent brushing of the lock so that sensor 26 confirms the lock has been touched at the exterior of the lock in the absence of an authorized remote access device 15, When this combination is determined to be present by the controller the door locks. In another embodiment, multiple touches to sensor 26 embedded within lock 11 may cause, in the absence of an authorized remote access control device, locking of the door.

A variation on this process can be utilized to remind the user they have forgotten their authorized remote access device 15. Controllers 21, 32 may be programmed to recognize that upon recognition of a remote access device, a single touch at sensing device 26 allows control to the user to either lock or unlock lock 11. If the user touches the lock 11 a single time and locking does not occur, this can act as a reminder that they have forgotten the remote access device. Furthermore, controller 21 could control the visual display 216 and the like to indicate the open or locked condition to user 70 so that they may recognize that the lock is not acting in accordance with expectations because of the absence of the remote access device 15.

A mechanical or zero/low-power tilt sensor may be configured to detect break-in events, for example to the lock 11 eased upon a detected break-in, the lock 11 activate and thereafter communicate to home-connect plugin 30 to report an intruder alert. The lock 11 may also store information, in a memory, for example, if home-connect plugin is off-line. Radar or other motion detector device (not shown) may also be added to the home-connect plugin 30 to assist with inside/outside determination and break-in monitoring. The radar or other motion detector may be used in conjunction with an alarm system, as will be appreciated by those skilled in the art.

Indeed, while the different components of the wireless access system 10 have been described with respect to a wireless protocol, it will be appreciated by those skilled in the art that the components may communicate via a wired network and protocols or a combination of wired and wireless networks. Additionally, while Bluetooth and WLAN (i.e. WiFi) has been described herein as wireless protocols of particular merit, other wireless protocols may be used, for example, Zywave, ZigBee, near field communication (NFC), and other wireless protocols.

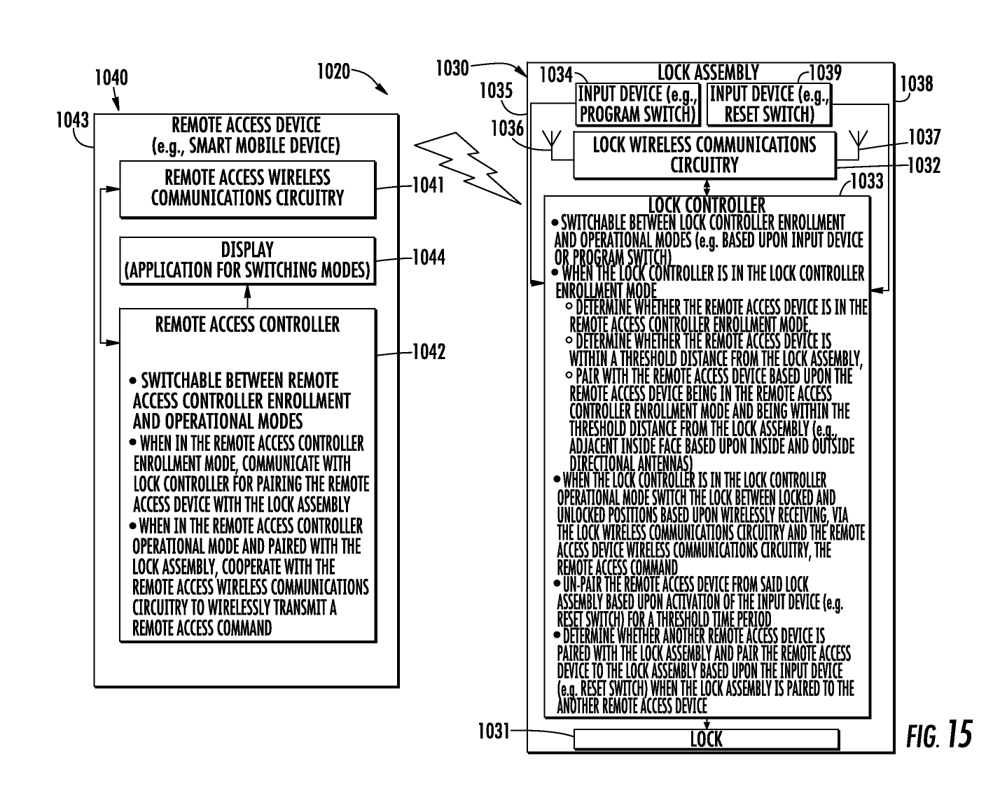

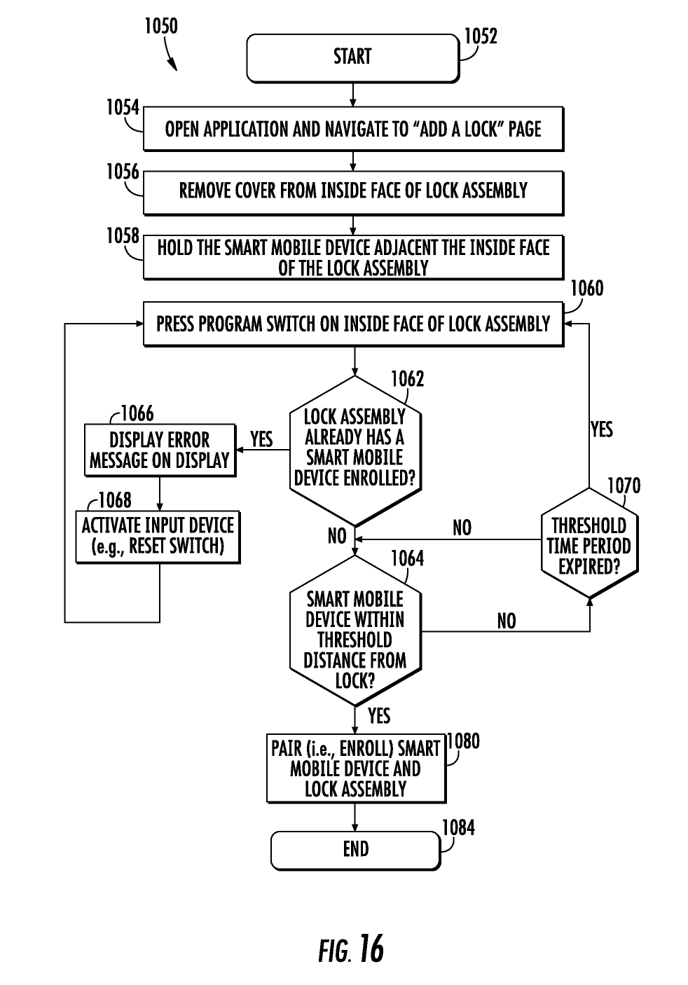

Referring now to FIGS. 14 and 15, further details of enrolling an administrator, the first user, or other users, the system can utilize a tap proximity method as an alternative to a PIN or password, as described above, will now be described. In particular, a wireless access control system 1020 for a door 1021, includes a lock assembly 1030 carried by the door. The lock assembly 1030 includes a lock 1031, lock wireless communications circuitry 1032, and a lock controller 1033 coupled to the lock and the lock wireless communications circuitry.

The lock controller 1033 is switchable between a lock controller enrollment mode and a lock controller operational mode. For example, in the lock controller operational mode, the lock controller 1033 is able to learn or pair with a new remote access device 1040 that controls operation of the lock 1031 between locked and unlocked positions.

The remote access device 1040 is remote from the lock assembly 1031 and includes remote access wireless communications circuitry 1041, and a remote access controller 1042 coupled to the remote access wireless communications circuitry. The remote access controller 1042 is also switchable between a remote access controller enrollment mode and a remote access controller operational mode, for example, for pairing with the lock assembly 1030.

The remote access controller 1042, when in the remote access controller enrollment mode, communicates with the lock controller 1033 for pairing the remote access device 1040 with the lock assembly 1030. When in the remote access controller operational mode and paired with the lock assembly 1030, the remote access controller 1042 cooperates with the remote access wireless communications circuitry 1041 to wirelessly transmit a remote access command.

The lock controller 1033 may be switched to the lock controller enrollment mode based upon a first input device 1034, for example, a program switch, which is adjacent an inside face 1035 of the lock assembly 1030. The lock controller 1033, when the lock controller is in the lock controller enrollment mode, determines whether the remote access device 1040 is in the remote access controller enrollment mode, and determines whether the remote access device is within a threshold distance from the lock assembly 1030. The lock controller 1033 also pairs with the remote access device 1040 based upon the remote access device being in the remote access controller enrollment mode and being within the threshold distance from the lock assembly 1030 that is less than a communication distance between the lock wireless communications circuitry 1032 and the remote access wireless communications circuitry 1041.

To determine whether the remote access device 1040 is within the threshold distance, the lock controller 1033, which includes an inside directional antenna 1036 directed from an inside face 1035 and an outside directional antenna 1037 directed from an outside face 1038, determines when the remote access device is adjacent the inside face based upon the inside and outside directional antennas.

When the lock controller 1033 is in the lock controller operational mode the lock controller switches the lock 1031 between locked and unlocked positions based upon wirelessly receiving, via the lock wireless communications circuitry 1032 and the remote access device wireless communications circuitry 1041, the remote access command.

If the lock controller 1033 is already paired with a remote access device 1040, for example, in some embodiments, further pairing is not permitted. Thus, the lock assembly 1030 may be reset by way of a second input device 1039 or a reset switch adjacent the inside face 1035 of the lock assembly 1030. To reset the lock assembly 1030, the reset switch 1039 is activated for a threshold time period so that the previous lock assembly—remote access device pairing is removed and so that a new lock assembly remote access device pairing may be performed.

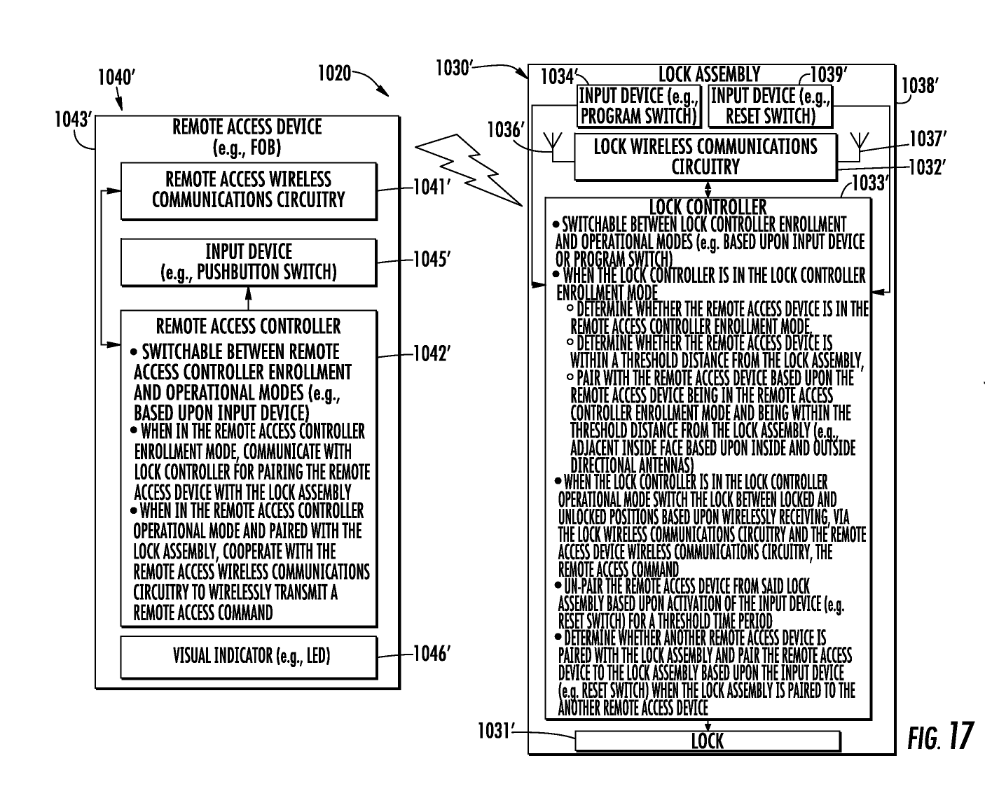

Referring now additionally to the flowchart 1050 in FIG. 16, and beginning at Block 1052, an exemplary pairing operation will now be described. After a user physically installs the lock assembly 1030 on his or her door 1021, for operation of the lock 1031, the user enrolls his remote access device, which is illustratively in the form of a mobile wireless communications device or smart mobile device 1040. The smart mobile device includes a housing 1043 carrying the remote access wireless communications circuitry 1041 and the remote access controller 1042, and a display 1044 carried by the housing and coupled to the remote access controller. Access to, for example, enrollment, and operation of the lock 1031 may be performed by an application displayed on the display 1044. The remote access controller 1042 may be switched from the remote access device operational mode to the remote access device enrollment mode via the application.

To enroll a remote access device in the form of a smart mobile device, the user opens the application and navigates to an “Add a Lock” page, for example (Block 1054). The “Add a Lock” page instructs the user to remove a cover from the inside face 1035 of the lock assembly 1030 (Block 1056), for example, the battery cover, and physically hold the smart mobile device 1040 adjacent the inside face of the lock assembly (Block 1058), and press the program switch 1034 on the inside face 1035 of the lock assembly (Block 1060). By “up to” it is meant that the smart mobile device 1040 be brought in close physical proximity to the lock assembly 1030 and that there may be no physical contact (e.g. similar to NFC, but with Bluetooth low energy).

Upon opening the “Add a Lock” page, the smart mobile device 1040 enters the remote access device enrollment mode during which the smart mobile device emits a signal indicating that it is ready to pair with the lock assembly. When the user presses the program switch 1034 while the smart mobile device 1040 is in the remote access device enrollment mode, the lock assembly 1030 and the smart mobile device connect, and the lock controller 1033 determines (a) whether or not the lock assembly already has a smart mobile device enrolled (Block 1062) and (b) whether or not the smart mobile device is sufficiently close to the lock (Block 1064). The determination of whether the smart mobile device is sufficiently close to the lock assembly 1030′ may be based upon a received signal strength intensity (RSSI) at the directional antennas 1036, 1037 of the lock assembly 1030. If there is no lock owner currently enrolled to the lock assembly 1030 (Block 1062) and the smart mobile device 1040 is within the RSSI threshold (Block 1064), the user's account associated with the application running on the smart mobile device becomes enrolled as the lock owner (Block 1080).

If the lock assembly 1030 already has a smart mobile device 1040 enrolled, for example, at Block 1062, the smart mobile device displays an error message on the display 1044 indicating that the lock assembly is to be reset to enroll the lock (Block 1066). To reset the lock assembly 1030, the reset switch 1039 on the inside face 1035 of the lock assembly 1030 is activated for about 7 to 10 seconds, for example (Block 1068). Of course, the reset switch 1039 may be activated for other durations of time.

Those skilled in the art will appreciate that, by way of the reset switch 1039, the lock assembly 1030 could be reset, which would delete the owner or remote access device associated with the lock assembly and all other pending/active electronic keys that are paired with the lock assembly. However, if there was no reset switch 1039 on the inside face 1035 of the lock assembly 1030, there may be a situation where the lock owner sells or gives away his/her lock assembly without the lock owner revoking his/her ownership status rendering the lock assembly unusable to the new owner. In this case, the new owner may call a customer service center and request that a customer service representative wirelessly override and/or delete the ownership status of the lock assembly 1030 in a remote server, however, this technique relies on the customer's word which may not necessarily be reliable.

By performing a physical action to revoke the ownership status of the lock assembly 1030, a wrong decision to remove a lock assembly owner's access may be avoided. Also, remote owner deletion through unauthorized access to the lock assembly (i.e., hacking) may also be reduced.

The first time the lock assembly 1030 is enrolled (either in an out-of-the box situation or the first time after reset), the user's account logged into the smart mobile device 1040 becomes the “owner” of the lock (Block 1080). There can only be one lock owner at a time, and after the lock has a lock owner, the lock owner is the only one that can send out eKeys for one or more other smart mobile device users to have access to the lock.

After a reset at Block 1066, the user may have to again press the program switch (Block 1060) to repeat the enrollment steps. Also, if the smart mobile device 1040 is not within the threshold distance (Block 1064) within a threshold time period (Block 1070), the process may time out and the user may have to again press the program switch (Block 1060). The process ends at Block 1084.

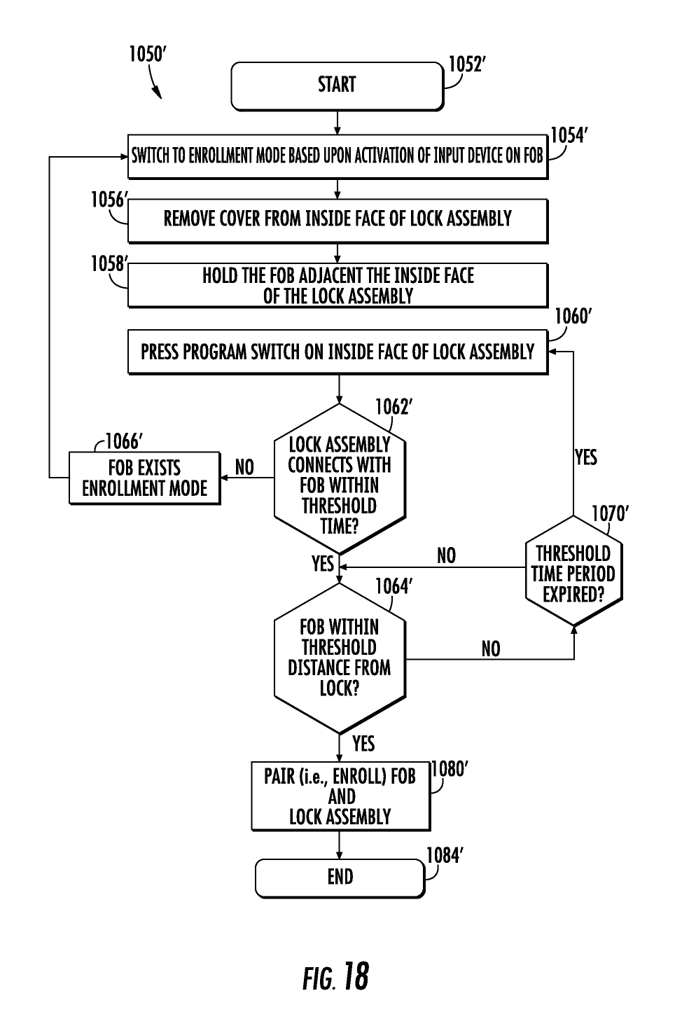

Referring now to FIG. 17 and the flowchart 1050′ in FIG. 18, in another embodiment, the remote access device may be a fob 1040′ and may include a fob housing 1043′ carrying the remote access wireless communications circuitry 1041′ and the remote access controller 1042′. An input device 1045′ is carried by the fob housing 1044′ and coupled to the remote access controller 1042′. The remote access controller 1042′ is configured to switch from the remote access device operational mode to the remote access device enrollment mode based upon the input device 1045′.

Beginning at Block 1052′, when the fob 1040′ enters the remote access device enrollment mode (Block 1054′), a visual indicator in the form of a light emitting diode (LED) 1046′ activates as a slow blinking green light indicating that the fob is ready to enroll to a lock assembly 1030′. The user holds up the fob 1040′, which is in the remote access device enrollment mode, to the interior face 1035′ of the lock assembly 1030′ (Block 1058′), after removing the cover from the inside face of the lock assembly (Block 1056′), and presses (e.g., simultaneously) the program switch 1034′ on the inside face of the lock assembly (Block 1060′).

Pressing the program switch 1034′ causes the lock controller 1033′ to scan for remote access devices. The lock controller 1033′ discovers the fob 1040′, and the lock assembly 1030′ and fob make a connection. If the fob 1040′ does not make a connection within a threshold time period after the user activates the input device 1045′ of the fob (Block 1062′), the fob exits the remote access device enrollment mode (Block 1066′) (as indicated by the LED 1046′ flashing red) and also returns to a low power mode.

When the lock assembly 1030′ and the fob 1040′ make a connection, the lock assembly, by way of the lock controller 1033′ queries the fob. The fob 1040′, in the remote access device enrollment mode tells the lock assembly 1030′ that it wants to enroll, and the device starts the enrollment process. When the enrollment process starts, the LED 1046′ changes from slow blinking green to fast blinking green for the duration of the enrollment process.

The next step in the enrollment process includes checking the received signal strength intensity (RSSI) from the fob 1040′ based upon the received signal strength at the directional antennas 1036′, 1037′ of the lock assembly 1030′ (Block 1064′). For the enrollment process to complete, the fob 1040′ should be sufficiently close to the lock assembly 1040′, that is, the RSSI from the fob must exceed some predetermined threshold value as measured in dBm for successful enrollment, for example, about 5 feet, which is less than the communication distance therebetween.

If the following for enrollment are met, (a) the user puts the fob 1040′ in remote access device enrollment mode (Block 1054′), (b) the user presses the program switch 1034′ on the inside face 1035′ of the lock assembly 1030′ (Block 1060′), and (c) the fob is sufficiently close to the lock assembly (Block 1064′), the fob will successfully enroll to the lock assembly (Block 1080′). To indicate successful enrollment the LED 1046′ of the fob 1040′ changes from a fast blinking green to solid green for about a second. If the fob 1040′ is not within the threshold distance (Block 1064′) within a threshold time period (Block 1070′), the process may time out and the user may have to again press the program switch 1034′ (Block 1060′) and/or switch the fob back into the enrollment mode (Block 1054′). The process ends at Block 1084.

The fob 1040′ may communicate using, for example, a public key infrastructure (PKI). The PKI provides for a secure way for the lock to create permissions for and manage access by another device (phone or fob) after the permissions are created. With PKI, the fob enrollment process includes both the lock and the fob generating a “shared secret.” After enrollment, the fob 1040′ is authorized to access the lock assembly 1030′. When a user carrying an authorized fob performs a touch to lock/unlock, for example, using a touch sensor, the lock assembly 1030′ and the fob 1040′ securely verify that they still share the same shared secret. The touch to lock/unlock process may be based upon a capacitive touch sensor, a pressure sensor, a pushbutton switch, or other touch sensor as will be appreciated by those skilled in the art. The process ends at Block 1084′.

A method aspect is directed to a method of pairing the lock assembly 1030 and the remote access device 1040. The method includes using the remote access controller 1042 to, when in the remote access controller enrollment mode, communicate with the lock controller 1033 for pairing the remote access device with the lock assembly 1030, and when in a remote access controller operational mode and paired with the lock assembly, cooperate with the remote access wireless communications circuitry 1041 to wirelessly transmit a remote access command. The method may also include using the lock controller 1033 to, when the lock controller is in the lock controller enrollment mode, determine whether the remote access device 1040 is in the remote access controller enrollment mode, determine whether the remote access device is within a threshold distance from the lock assembly less than a communication distance between the lock wireless communications circuitry 1032 and the remote access wireless communications circuitry 1041, and pair with the remote access device based upon the remote access device 1040 being in the remote access controller enrollment mode and being within the threshold distance from the lock assembly. The method may also include using the lock controller 1033 to, when the lock controller is in the lock controller operational mode, switch the lock 1031 between locked and unlocked positions based upon wirelessly receiving, via the lock wireless communications circuitry 1032 and the remote access device wireless communications circuitry 1041, the remote access command.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included as readily appreciated by those skilled in the art.

That which is claimed is:

1. A wireless access control system for a door, the wireless access control system comprising:
a lock assembly carried by the door and comprising
a lock,
lock wireless communications circuitry, and
a lock controller coupled to said lock and said lock wireless communications circuitry and switchable between a lock controller enrollment mode and a lock controller operational mode;
a remote access device remote from said lock and comprising
remote access wireless communications circuitry, and
a remote access controller coupled to said remote access wireless communications circuitry and switchable between a remote access controller enrollment mode and a remote access controller operational mode, said remote access controller configured to
when in the remote access controller enrollment mode, communicate with said lock controller for pairing said remote access device with said lock assembly,
when in the remote access controller operational mode and paired with said lock assembly, cooperate with said remote access wireless communications circuitry to wirelessly transmit a remote access command;
said lock controller configured to
when said lock controller is in the lock controller enrollment mode
determine whether said remote access device is in the remote access controller enrollment mode,
determine whether said remote access device is within a threshold distance from said lock assembly less than a communication distance between said lock wireless communications circuitry and said remote access wireless communications circuitry, and
pair with said remote access device based upon said remote access device being in the remote access controller enrollment mode and being within the threshold distance from said lock assembly, and
when said lock controller is in the lock controller operational mode switch said lock between locked and unlocked positions based upon wirelessly receiving, via said lock wireless communications circuitry and said remote access device wireless communications circuitry, the remote access command.

2. The wireless access control system of claim 1 wherein said lock assembly has an inside face and an outside face; and wherein said lock controller is configured to pair with said remote access device when said remote access device is adjacent the inside face of said lock assembly and within the threshold distance thereto.

3. The wireless access control system of claim 2 wherein said lock assembly comprises:
an inside directional antenna directed from the inside face; and
an outside directional antenna directed from the outside face;
said lock controller is configured to determine when said remote access device is adjacent the inside face based upon said inside and outside directional antennas.

4. The wireless access control system of claim 1 wherein said lock assembly further comprises an input device configured to switch the lock controller to the lock controller enrollment mode.

5. The wireless access control system of claim 4 wherein said lock assembly has an inside face and an outside face; and wherein said input device is accessible from the inside face.

6. The wireless access control system of claim 1 wherein said lock assembly further comprises an input device coupled to said lock controller; and wherein said lock controller is configured to un-pair said remote access device from said lock assembly based upon activation of said input device for a threshold time period.

7. The wireless access control system of claim 1 wherein said lock assembly further comprises an input device coupled to said lock controller; and wherein said lock controller is configured to determine whether another remote access device is paired with said lock assembly and pair said remote access device to said lock assembly based upon said input device when said lock assembly is paired to the another remote access device.

8. The wireless access control system of claim 1 wherein said remote access device further comprises:
a housing carrying said remote access wireless communications circuitry and said remote access controller; and
a display carried by said housing and coupled to said remote access controller;
said remote access controller being configured to display on said display an application for switching from the remote access device operational mode to the remote access device enrollment mode.

9. The wireless access control system of claim 1 wherein said remote access device further comprises:
a fob housing carrying said remote access wireless communications circuitry and said remote access controller; and
at least one input device carried by said fob housing and coupled to said remote access controller;
said remote access controller being configured to switch from the remote access device operational mode to the remote access device enrollment mode based upon said input device.

10. A lock assembly to be carried by a door, the lock assembly comprising:
a lock;
lock wireless communications circuitry; and
a lock controller coupled to said lock and said lock wireless communications circuitry and switchable between a lock controller enrollment mode and a lock controller operational mode, said lock controller configured to
when said lock controller is in the lock controller enrollment mode
determine whether a remote access device is in a remote access enrollment mode, the remote access device switchable between a remote access enrollment mode and a remote access operational mode, the remote access device, when in the remote access enrollment mode, communicating with said lock controller for pairing the remote access device with said lock assembly, and when in the remote access operational mode and paired with said lock assembly, wirelessly transmit a remote access command,
determine whether the remote access device is within a threshold distance from said lock assembly less than a communication distance between said lock wireless communications circuitry and said remote access wireless communications circuitry, and
pair with the remote access device based upon the remote access device being in the remote access controller enrollment mode and being within the threshold distance from the lock assembly, and
when said lock controller is in the lock controller operational mode switch said lock between locked and unlocked positions based upon wirelessly receiving, via said lock wireless communications circuitry, a remote access command.

11. The lock assembly of claim 10 further comprising an inside face and an outside face; and wherein said lock controller is configured to pair with the remote access device when the remote access device is adjacent the inside face of said lock assembly and within the threshold distance thereto.

12. The lock assembly of claim 11 wherein said lock assembly further comprises:
an inside directional antenna directed from the inside face; and
an outside directional antenna directed from the outside face;
said lock controller is configured to determine when said remote access device is adjacent the inside face based upon said inside and outside directional antennas.

13. The lock assembly of claim 10 further comprising an input device configured to switch the lock controller to the lock controller enrollment mode.

14. The lock assembly of claim 13 further comprising an inside face and an outside face; and wherein said input device is accessible from the inside face.

15. The lock assembly of claim 13 further comprising an input device coupled to said lock controller; and said lock controller is configured to un-pair said remote access device from said lock assembly based upon activation of said input device for a threshold time period.

16. A method of pairing a lock assembly and a remote access device in a wireless access control system for a door, the lock assembly carried by the door and comprising a lock, lock wireless communications circuitry, and a lock controller coupled to the lock and the lock wireless communications circuitry and switchable between a lock controller enrollment mode and a lock controller operational mode, and the remote access device being remote from the lock and comprising remote access wireless communications circuitry, and a remote access controller coupled to the remote access wireless communications circuitry and switchable between a remote access controller enrollment mode and a remote access controller operational mode, the method comprising:
using the remote access controller to
when in the remote access controller enrollment mode, communicate with the lock controller for pairing the remote access device with the lock assembly,
when in the remote access controller operational mode and paired with the lock assembly, cooperate with the remote access wireless communications circuitry to wirelessly transmit a remote access command; and
using the lock controller to
when the lock controller is in the lock controller enrollment mode
determine whether the remote access device is in the remote access controller enrollment mode,
determine whether the remote access device is within a threshold distance from the lock assembly less than a communication distance between said lock wireless communications circuitry and said remote access wireless communications circuitry, and
pair with the remote access device based upon the remote access device being in the remote access controller enrollment mode and being within the threshold distance from the lock assembly, and
when the lock controller is in the lock controller operational mode switch the lock between locked and unlocked positions based upon wirelessly receiving, via the lock wireless communications circuitry and the remote access device wireless communications circuitry, the remote access command.

17. The method of claim 16 wherein the lock assembly has an inside face and an outside face; and wherein the lock controller is used to pair the remote access device when the remote access device is adjacent the inside face of the lock assembly and within the threshold distance thereto.

18. The method of claim 17 wherein the lock assembly comprises an inside directional antenna directed from the inside face and an outside directional antenna directed from the outside face; and wherein the lock controller is used to determine when the remote access device is adjacent the inside face based upon the inside and outside directional antennas.

19. The method of claim 16 wherein the lock controller is used to switch the lock controller enrollment mode based upon activation of an input device.

20. The method of claim 16 wherein the lock controller is used to determine whether another remote access device is paired with the lock assembly and pair the remote access device to the lock assembly based upon an input device when the lock assembly is paired to the another remote access device.
